(19) United States
(12) Patent Application Publication
(10) Pub. No.: US 2024/0345220 A1
(43) Pub. Date: Oct. 17, 2024

(54) WIRELESS CONNECTIVITY AND MOTION/GESTURE MONITORING IN A NETWORK ENVIRONMENT

(71) Applicant: Charter Communications Operating, LLC, St. Louis, MO (US)

(72) Inventors: Hany A. Heikal, Aurora, CO (US); Mohamed Daoud, Englewood, CO (US); Hossam H. Hmimy, Surora, CO (US)

(21) Appl. No.: 18/134,286

(22) Filed: Apr. 13, 2023

(51) Int. Cl. G01S 7/41; G01S 7/00; G01S 13/00; G01S 13/88; G06Q 30/0202

(52) U.S. Cl. CPC G01S 7/415; G01S 7/006; G01S 13/003; G01S 13/88; G06Q 30/0202

(57) ABSTRACT

A wireless system as discussed herein transmits wireless signals from a wireless access point in a network environment. Via the wireless signals transmitted from the wireless access point, a management resource detects presence of a person in a network environment. The management resource monitors motion of the person based on reflections of the wireless signals off the person in the network environment.

### BACKGROUND

Conventional shopping analysis includes the process of acquiring information on consumer behavior in a retail setting and using that behavior information to determine the customer's preferences and/or purchasing patterns.

The following list includes some of the variables that may be considered throughout the analysis:
The shopping environment and how consumers navigate it.
The number of customers at the store at a particular time or over a specific period.
The characteristics of the goods.
The price of the goods.
The hours that people go shopping.
Anticipate shoppers' needs and desire.
Discover the points of engagement and friction in the shopping process.
Improve the retail experience and measure how shoppers respond.
Increase business performance
Optimize the shop ability of the store

Using collected data, staff members in marketing, sales, and logistics may forecast market consumption trends, which is helpful when choosing products, launching promotions, and planning store layouts.

If desired, conventional collected video monitoring data of consumer behavior can be represented as a heatmap overlapped with respect to the products. That enables marketing and sales member to visualize consumer reaction to different available products.

Conventional systems that track consumers' behavior typically use Machine Learning for Video analytics. For example, a conventional monitoring system may implement several cameras inside a store environment. An analyzer analyzes the captured video using a conventional Deep Neural network as a Machine Learning technique. The conventional analyzer can be configured to include one or more models to analyze an entire human body or create a skeleton for the human body.

Each one of these conventional models can be configured to predict movement of the human body. The developers of these solutions gather the data such as: Where the shopper is standing.
Their skeleton positions
Where they're reaching.
Where their head is facing.
Their facial expressions

The collected video data is then used to create a head-map graph mentioned above. Such information may be accessible to store members and/or sales and marketing teams. The teams analyze the video data and adjust one or more attributes of the product to drive more sales and visibility.

### BRIEF DESCRIPTION OF EMBODIMENTS

This disclosure includes the observation that conventional solutions of monitoring consumers in a retail environment suffer from deficiencies. For example, one drawback of the conventional solution of monitoring consumer behavior as previously discussed is that it is solely dependent on video cameras and collection of video data. This creates a problem for consumers' privacy and potentially makes them feel that they are constantly being watched. The privacy concerns could turn consumers away from coming to the store itself, resulting in loss of sales.

Embodiments herein provide improved implementation of wireless access networks and expanded use of wireless bandwidth to monitor motion in a network environment.

More specifically, a wireless system includes one or more wireless access points to provide wireless access to a remote network such as the Internet. The wireless system transmits wireless signals from a wireless access point in a network environment. Via the wireless signals transmitted from the wireless access point, the wireless system detects presence of a person in the network environment. Based on reflections of the wireless signals off the person in the network environment, the wireless system monitors attributes such as motion of the person.

In accordance with further examples, the monitor system as discussed herein determines a location of the person in the network environment based on reception of the reflections of the wireless signals at multiple different wireless sensors in the network environment. If desired, the monitor system monitors shopping activity of the person viewing products available for sale on a shelf in the network environment.

In accordance with still further examples, the monitor system as discussed herein can be configured to detect, based on the reflections of the wireless signals off of the person, behavior such as the person acquiring an item from a shelf.

Still further, the wireless signals can be configured to include a first wireless signal transmitted from the wireless access point. Monitoring of the motion of the person may include: i) receiving a first reflection of the first wireless signal off the person, and ii) mapping a signature (such as frequency shifts) associated with the reflection of the first wireless signal to an action type to determine the type of motion associated with the person.

Yet further, note that the wireless signals can be configured to include a first wireless signal and a second wireless signal. Monitoring the motion of the person includes: i) at a first wireless signal sensor, receiving a first reflection of the first wireless signal off the person, ii) at a second wireless signal sensor disparately located with respect to the first wireless senor, receiving a second reflection of the first wireless signal off the person, and iii) mapping a combination of a first signature of the first reflection of the wireless signal and a second signature of the first reflection of the wireless signal to an action performed by the person.

The wireless signals can be configured to transmitted at one or more wireless frequencies. For example, transmitting the wireless signals from the wireless access point may include transmitting a first wireless signal from the wireless access point at a first wireless frequency. Monitoring the motion of the person includes determining a frequency shift of one or more reflections of the first wireless signal off of the person in the network environment with respect to the first wireless frequency associated with the transmitted first wireless signal.

In accordance with still further examples, the monitor system as discussed herein transmits a first wireless signal from the wireless access point to a communication device operated by the person. Monitoring the motion of the person via the monitor system includes analyzing a reflection of the first wireless signal off of the person.

Further examples of detecting the presence of the person in the network environment as discussed herein include, via the monitor system: i) receiving a wireless communication from a mobile communication device operated by the person, and ii) mapping a unique identifier value in the received wireless communication to an identity of the person. Based on the monitored motion of the person, the monitor system communicates a message from the first wireless access point to the mobile communication device.

Techniques as discussed herein are useful over conventional techniques. For example, one or more implementation of a communication management resource and corresponding operations as discussed herein: i) provide consumer privacy by using the wireless sensing technology, which does not expose the consumers' faces or the contour of their bodies, ii) leverage existing hardware and infrastructure, enable new services, and provide a higher level of interaction with networked devices, iii) eliminate the need for good lighting conditions required by video capturing systems, and iv) prevent the need for line of sight monitoring since wireless signals can even pass through walls.

Note that any of the resources as discussed herein can include one or more computerized devices, mobile communication devices, sensors, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different embodiments as described herein.

Yet other embodiments herein include software programs to perform the steps and operations summarized above and disclosed in detail below. One such embodiment comprises a computer program product including a non-transitory computer-readable storage medium or any computer readable hardware storage medium on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, memory device, etc., or other medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, embodiments herein are directed to a method, system, computer program product, etc., that supports operations as discussed herein.

One embodiment includes a computer readable storage medium and/or system having instructions stored thereon. The instructions, when executed by the computer processor hardware, cause the computer processor hardware (such as one or more co-located or disparately processor devices or hardware) to: transmit wireless signals from a wireless access point in a network environment; via the wireless signals transmitted from the wireless access point, detect presence of a person in a network environment; and monitor motion of the person based on reflections of the wireless signals off the person in the network environment.

The ordering of the steps above has been added for clarity sake. Note that any of the processing steps as discussed herein can be performed in any suitable order.

Other embodiments of the present disclosure include software programs and/or respective hardware to perform any of the method embodiment steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of monitoring behavior of consumers in a retail environment. However, it should be noted that embodiments herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of embodiments herein (BRIEF DESCRIPTION OF EMBODIMENTS) purposefully does not specify every embodiment and/or incrementally novel aspect of the present disclosure or claimed invention(s). Instead, this brief description only presents general embodiments and corresponding points of novelty over conventional techniques. For additional details and/or possible perspectives (permutations) of the invention(s), the reader is directed to the Detailed Description section (which is a summary of embodiments) and corresponding figures of the present disclosure as further discussed below.

### BRIEF DESCRIPTION OF THE DRAWINGS

FIG. 1 is an example diagram illustrating a network environment and implementation of motion-gesture monitoring as described herein.

FIG. 2 is an example diagram illustrating different learned Doppler radar signatures of detected motion-gestures of a person as described herein.

FIG. 3 is an example diagram illustrating transmission of one or more wireless signals from a wireless access point and monitoring of corresponding reflections off an object (such as a person) at one or more sensors as described herein.

FIG. 4 is an example diagram illustrating monitoring of a respective user in a retail environment as described herein.

FIG. 5 is an example diagram illustrating generation of tracking information indicating corresponding detected locations and movement associated with a person (such as a consumer) in a retail environment as described herein.

FIG. 6 is an example diagram illustrating a network environment and implementation of motion-gesture monitoring associated with a user of a mobile communication device as described herein.

FIG. 7 is an example diagram illustrating implementation of a respective display screen on a mobile communication device to display desired items for purchase in a retail environment as described herein.

FIG. 8 is an example diagram illustrating transmission of wireless signals from a wireless access point and corresponding wireless signal reflections off an object (such as a person) to one or more sensors as described herein.

FIG. 9 is an example diagram illustrating monitoring of a respective user in a retail environment as described herein.

FIG. 10 is an example diagram illustrating monitor information indicating detected movement associated with a person in a retail environment as described herein.

FIG. 11 is an example diagram illustrating example computer hardware and software operable to execute operations according to embodiments herein.

FIG. 12 is an example diagram illustrating a method according to embodiments herein.

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

### DESCRIPTION OF EMBODIMENTS

Techniques as discussed herein include a monitor solution using wireless (such as Wi-Fi™) sensing instead of video analytics to determine motions and/or gestures (i.e., behavior) associated with a respective person or object in a retail or other environment. For example, depending on the physical electromagnetic propagation characteristics, permitted power levels, and allotted bandwidth, wireless signals can be transmitted in one or more different frequency bands, each wireless band offering a distinct variety of potential use cases. There are three major applications: Detection (binary classification), Recognition (multi-class classification), and Estimation (quantity values of size, length, angle, distance, etc.).

Wireless sensing as discussed herein depicts, tracks, and analyzes consumers' and objects' motion, behavior, and location using standard wireless signals, eliminating the need for deployment of multiple cameras in commercial buildings such as retail environments.

Wireless sensing as discussed herein can include implementing wireless signals and analyzing reflections to track movements and recognize behavior such as motion and/or human gestures. In order to use the same wireless transceiver hardware and RF spectrum for transmission and sensing, wireless sensing as discussed herein can be combined with already implemented wireless communication technology (such as conveying data via Wi-Fi™ or other suitable protocol) and RADAR (RAdio Detecting And Ranging) sensing technology.

As discussed herein, the wireless signals (such as signals conveying data to a respective one or more users) can be implemented as RADAR such as Doppler Radar. Doppler Radar can be implemented as a Wi-Fi-™based sensing technology that employs the Doppler effect and standard Wi-Fi™ packets.

A Doppler radar is a specialized radar that uses the Doppler effect to produce velocity data about objects at a distance. It does this by bouncing a wireless signal off a desired target and analyzing how the object's motion has altered the frequency of the returned (reflected) wireless signal. This variation gives direct and highly accurate measurements of the radial component of a target's velocity relative to the sensors.

Combining wireless Radar Spectrogram Image Capability and Machine Learning can create Wi-Fi™ sensing technology as discussed herein. This wireless (such as Wi-Fi™ or other suitable protocol) sensing technology can recognize human motions such as falling, walking, bending over, crouching, sitting down, standing up, etc. Video cameras rely heavily on good lighting and line of sight conditions for good video capturing for further analysis using machine learning.

In contrast to conventional techniques, as further discussed herein, a wireless system includes one or more wireless access points implemented in a wireless network environment to provide one or more mobile communication devices wireless access to a remote network such as the Internet. To support behavior monitoring and potentially communicate data to a mobile communication device, the wireless system transmits wireless signals from a first wireless access point in a network environment. Via the wireless signals transmitted from the wireless access point, the wireless system detects presence of a person in the network environment. For example, based on reflections of the wireless signals off each person in the network environment, the wireless system monitors behavior such as motion/gestures/expressions/etc. of one or more persons in the network environment.

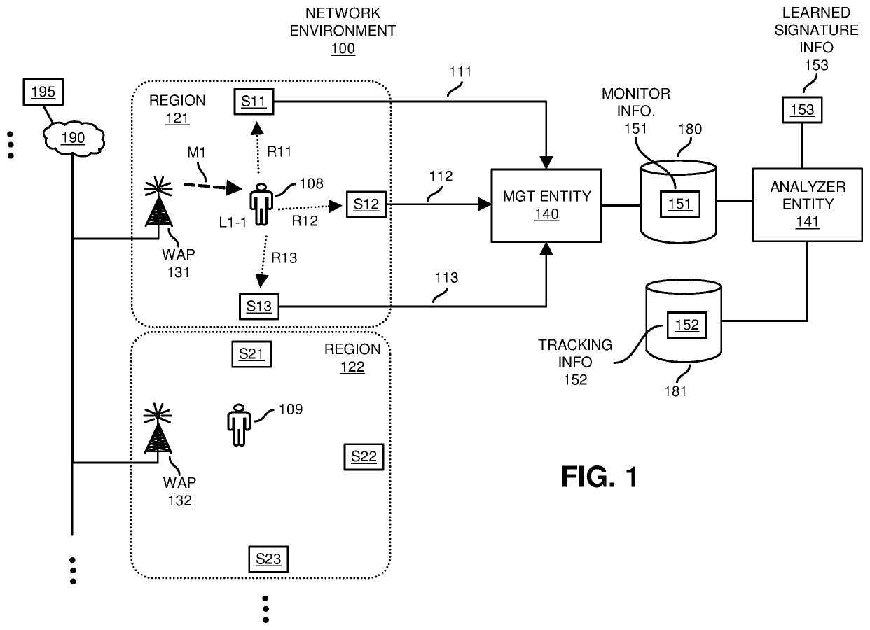

FIG. 1 is an example diagram illustrating a network environment and implementation of motion-gesture monitoring as described herein.

As shown in FIG. 1, the network environment 100 includes server 195, network 190, wireless access point 131, wireless access point 132, management entity 140 (such as communication management entity, monitor management entity, controller, etc.), repository 180, repository 181, and analyzer entity 141.

Note that each of the components in network 100 can be implemented in any suitable manner. For example, wireless access point 131 can be implemented as wireless access point hardware, wireless access point software, or a combination of wireless access point hardware and wireless access point software; wireless access point 132 can be implemented as wireless access point hardware, wireless access point software, or a combination of wireless access point hardware and wireless access point software; each of the sensors S11, S12, S13, S21, S22, S33, etc., can be implemented as respective sensor hardware, respective sensor software, or a combination of respective sensor hardware and respective sensor software; management entity 140 can be implemented as management entity hardware, management entity software, or a combination of management entity hardware and management entity software; analyzer entity 141 can be implemented as analyzer entity hardware, analyzer entity software, or a combination of analyzer entity hardware and analyzer entity software; and so on.

Note that the management entity 140 and corresponding executed functionality can be co-located or disparately located with respect to each other. The management entity 140 can be configured to support any of the functionality as discussed herein. The analyzer entity 141 and corresponding executed functionality can be co-located or disparately located with respect to each other. The analyzer entity 141 can be configured to support any of the functionality as discussed herein.

As further discussed herein, the management entity 140 can be configured to monitor behavior such as motion and/or gestures associated with one or more persons disposed in each of the different regions. For example, as shown, the region 121 includes wireless access point 131. The wireless access point 131 provides one or more mobile communication devices in the region 121 wireless access through the wireless access point 131 to the network 190 such as the Internet. Via the wireless access provided by the wireless access point 131, the one or more mobile communication devices in the region 121 are able to access one or more servers 195.

In addition to providing the one or more mobile communication devices access to the network 190 through the wireless access point 131, the wireless access point 131 can be configured to transmit wireless signals M1 in the region 121 of network environment 100. Via the wireless signals M1 transmitted from the wireless access point 131, the management entity 140 detects presence of one or more persons in the region 121 of the network environment 100.

Note that the wireless signals M1 may or may not include data communicated to a specific target in the network environment 100.

In one embodiment, the management entity 140 initiates transmission of the wireless signals M1 from the wireless access point 131 in the region 121 such as via one or more control signals from the management entity 140 to the wireless access point 131.

As further shown, the region 121 includes one or more sensors S11, S12, S13, etc., to monitor reflections of the wireless signals M1 transmitted by the wireless access point 131.

For example, different wireless energy from the wireless signals M1 transmitted from the wireless access point 131 are reflected as wireless signals R11, R12, R13, etc., off of the user 108 to sensors. A respective sensor converts a respective received reflected wireless signal into an electrical signal and provides notification of the reflected signal and/or its attributes (such as wireless frequency of the reflected signal, an exact time of receiving the reflected signal, etc.) to the management entity 140.

More specifically, in this example, via management entity 140, each of the sensors S11, S12, S13, etc., and wireless access point 131 can be synchronized to a common master clock. The sensor S11 receives reflected wireless signal R11 (such as a first portion of wireless energy associated with the wireless signals M1 transmitted by the wireless access point 131); the sensor S11 determines attributes (such as time of receipt, frequency information, etc.) of the reflected wireless signal R11 and communicates the attributes to the management entity 140. The sensor S12 receives reflected wireless signal R12 (such as a second portion of wireless energy associated with the wireless signals M1 transmitted by the wireless access point 131); the sensor S12 determines attributes (such as time of receipt, frequency information, etc.) of the reflected wireless signal R12 and communicates the attributes to the management entity 140. The sensor S13 receives reflected wireless signal (such as a third portion of wireless energy associated with the wireless signals M1 transmitted by the wireless access point 131); the sensor S13 determines attributes (such as time of receipt, frequency information, etc.) of the reflected wireless signal R13 and communicates the attributes to the management entity 140.

Over time, the wireless access point 131 transmits multiple instances of the wireless signals M1 such as wireless signal M1-11 at time T11, wireless signal M1-12 at time T12, . . . , wireless signal M1-21 at time T21, wireless signal M1-22 at time T22, . . . wireless signal M1-31 at time T31, wireless signal M1-32 at time T32, . . . , wireless signal M1-41 at time T41, wireless signal M1-42 at time T42 . . . , wireless signal M1-51 at time T51, wireless signal M1-52 at time T52, . . . wireless signal M1-61 at time T61, wireless signal M1-62 at time T62, . . . , wireless signal M1-71 at time T71, wireless signal M1-72 at time T72, . . . , wireless signal M1-81 at time T81, wireless signal M1-82 at time T82, . . . , and so on.

As previously discussed, for each instance of transmitted wireless signal M1, the management entity 140 receives corresponding feedback from the one or more sensors and stores it as monitor information 151 in repository 180.

For example, for each sample value X, where X is any integer value 1, 2, 3, . . . 99, 100 . . . for transmitted wireless signal M1-X, the management entity 140 receives and produces respective monitor information 151 to include: i) feedback 111 from the sensor S11 indicating information such as an absolute time of receiving the reflected wireless signal R11-X (portion of wireless signal M1-X reflected off the user 108 to the sensor S11) as well as a magnitude of the frequency associated with the reflected wireless signal R11-X; ii) feedback 112 from the sensor S12 indicating information such as a time of receiving the reflected wireless signal R12-X (portion of wireless signal M1-X reflected off the user 108 to the sensor S12) as well as a magnitude of the frequency associated with the reflected wireless signal R12-X; iii) feedback 111 from the sensor S13 indicating information such as a time of receiving the reflected wireless signal R13-X (portion of wireless signal M1-X reflected off the user 108 to the sensor S13) as well as a magnitude of the frequency associated with the reflected wireless signal R13-X; and so on.

Thus, for transmitted wireless signal M1-1 (in other words, for X=1, or time value=1), the management entity 140 receives and produces monitor information 151 to include: i) feedback 111 from the sensor S11 indicating a time of receiving the reflected wireless signal R11-1 (portion of wireless signal M1-1 reflected off the user 108 to the sensor S11) as well as a magnitude of the frequency (such as frequency shift information indicating a signature of user motion) associated with the reflected wireless signal R11-1; ii) feedback 111 from the sensor S12 indicating a time of receiving the reflected wireless signal R12-1 (portion of wireless signal M1-1 reflected off the user 108 to the sensor S12) as well as a magnitude of the frequency (such as frequency shift information indicating a signature of user motion) associated with the reflected wireless signal R12-1; iii) feedback 111 from the sensor S13 indicating a time of receiving the reflected wireless signal R13-1 (portion of wireless signal M1-3 reflected off the user 108 to the sensor S13) as well as a magnitude of the frequency such as (frequency shift information indicating a signature of user motion) associated with the reflected wireless signal R13-1; and so on.

For transmitted wireless signal M1-11 (in other words, X=11), the management entity 140 receives and produces monitor information 151 to include: i) feedback 111 from the sensor S11 indicating a time of receiving the reflected wireless signal R11-11 (portion of wireless signal M1-11 reflected off the user 108 to the sensor S11) as well as a magnitude of the frequency associated with the reflected wireless signal R11-11; ii) feedback 112 from the sensor S12 indicating a time of receiving the reflected wireless signal R12-11 (portion of wireless signal M1-11 reflected off the user 108 to the sensor S12) as well as a magnitude of the frequency associated with the reflected wireless signal R12-11; iii) feedback 113 from the sensor S13 indicating a time of receiving the reflected wireless signal R13-11 (portion of wireless signal M1-11 reflected off the user 108 to the sensor S13) as well as a magnitude of the frequency associated with the reflected wireless signal R13-11; and so on.

For transmitted wireless signal M1-21 (in other words, X=21), the management entity 140 receives and produces monitor information 151 to include: i) feedback 111 from the sensor S11 indicating a time of receiving the reflected wireless signal R11-21 (portion of wireless signal M1-21 reflected off the user 108 to the sensor S11) as well as a magnitude of the frequency associated with the reflected wireless signal R11-21; ii) feedback 112 from the sensor S12 indicating a time of receiving the reflected wireless signal R12-21 (portion of wireless signal M1-21 reflected off the user 108 to the sensor S12) as well as a magnitude of the frequency associated with the reflected wireless signal R12-21; iii) feedback 113 from the sensor S13 indicating a time of receiving the reflected wireless signal R13-21 (portion of wireless signal M1-21 reflected off the user 108 to the sensor S13) as well as a magnitude of the frequency associated with the reflected wireless signal R13-21; and so on.

In this manner, the management entity 140 receives and stores monitor information 151 (such as feedback 111, feedback 112, feedback 113, etc.) for further processing by the analyzer entity 141.

As further shown, the analyzer entity 141 converts the received (collected) monitor information 151 into tracking information 152. The tracking information 152 indicates attributes such as location and/or behavior such as motion, gestures, expression, etc., of the user 108 as determined from the monitor information 151.

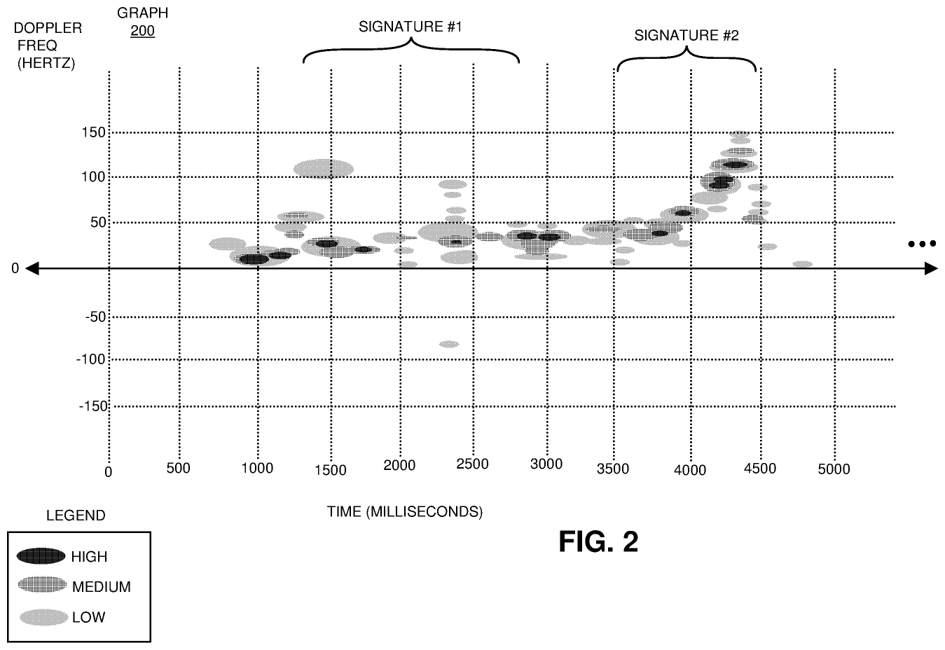

In accordance with further examples as shown in FIG. 2, the management entity 140 and analyzer entity 141 can be configured to learn a signature (such as based on one or more frequency shifts of an original wireless signal M1 transmitted by the wireless access point 131) received at each of the sensors for different test types of motions, gestures, expressions, etc., of any person in the network environment 100. This can include a test person performing a respective desired motion or gesture (test condition) and analyzing the corresponding feedback generated by the sensors for each respective test motion/gesture. A signature of the test motion is stored in learned signature information 153. Other persons performing the same motion results in the sensors producing the same or similar feedback as the test condition.

The management entity 140 or other suitable entity stores the learned signature information 153 including learned different types of feedback received from the sensors for different detected behavior such as motions, gestures, expression, etc., in the network environment.

In one example, the signature information 153 includes a collection of multiple different feedback entries for each of multiple different types of movement/expression/etc., enabling the analyzer entity 141 to map a collection or set of received feedback information (based on reflections R11, R12, R13, etc.) for each wireless signal M1-X to a corresponding type of detected motion, gesture, expression, etc., associated with the user 108. Based on the detected type of movement/expression/etc. of one or more person in the network environment 100, the analyzer entity 141 or other suitable entity can be configured to perform functions such as i) determine a better layout of shelving items in a retail environment, ii) learn about reactions of customers viewing an item for sale, iii) provide better guidance to the user to find different products in the retail environment, etc.

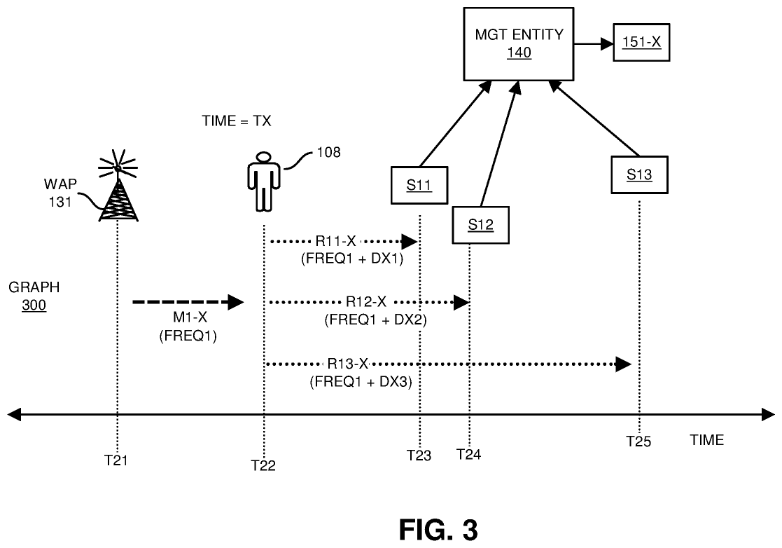

As shown in FIG. 3, in addition to the timing information and determine of motion, the analyzer entity 141 also uses the monitor information 151 to determine a respective location of the user 108 over time.

FIG. 2 is an example diagram illustrating different Doppler radar signatures of detected motion-gestures as described herein.

As previously discussed, during the learning mode, the management entity 140 or other suitable entity produces the learned signature information 153 to include corresponding signatures of different types of motion associated with persons in the network environment 100.

For example, as shown in graph 200, the management entity 140 determines for test condition #1 of a person walking event that signature #1 represents a motion of a person walking in the network environment 100; the management entity 140 determines for test condition #2 of a person falling event that signature #2 represents a person falling in the network environment 100; and so on. The management entity 140 or other suitable entity stores the detected signature information for each possible motion/gesture/expression/etc. in the learned signature information 153.

Thus, for each of multiple different detectable motions/gestures/expressions/etc., the management entity 140 or other suitable entity stores a Doppler feedback signature. Thus, the different signatures stored in learned signature information 153 correspond to example motion types such as: walking, pacing back-and-forth, head turning back and forth, crouching, acquisition of an item from a shelf, reading text on a label of an item, placing an item in a cart, placing an item back on the shelf, customer talking with store personnel, person looking down, person standing still, and so on.

FIG. 3 is an example diagram illustrating transmission of a respective wireless signal from a wireless access point and corresponding reflections off an object (such as a person) to one or more sensors as described herein.

Graph 300 illustrates transmission of a respective wireless signal M1-X (such as one or more wireless signals) from the wireless access point 131 for time TX. As previously discussed, it is known at what time (such as T21 or other suitable value) the wireless signal M1-X is transmitted from the wireless access point 131. The wireless signal M1-X is transmitted at a known frequency of FREQ1. The frequency FREQ1 can be any suitable frequency such as 2.4 GHz, 5 GHZ, 6.1 GHZ, etc.

As previously discussed, the first portion of the transmitted wireless signal M1-X reflects off the user 108 at time T22 as reflection R11-X. For example, a portion of the transmitted wireless signal M1-X reflects off the user 108 (person) as reflected signal R11-X to the sensor S11. Depending upon the motion associated with the user 108, the reflected wireless signal R11-X has a different frequency profile than the original frequency FREQ1 of the signal M1-X. In other words, the reflected frequency of the R11-X may be the same, higher, or lower than 2.4 GHz depending on a magnitude of motion of the user 108. More specifically, assume that the sensor S11 (such as a passive wireless sensor at a first known location in region 121) detects that the reflected wireless signal R11-X is received at time T23 and is received at a frequency of FREQ1+delta DX1 (delta DX1 represents a difference or frequency shift with respect to FREQ1, signal R11-X has a different frequency than FREQ1 due to doppler shift caused by movement of user 108).

A second portion of the transmitted wireless signal M1-X reflects off the user 108 at time T22. For example, a portion of the transmitted wireless signal M1-X reflects off the user 108 (person) as reflected signal R12-X to the sensor S12. Depending upon the motion associated with the user 108, the reflected wireless signal R12-X has a different frequency than the original frequency FREQ1 of the signal M1-X. In other words, the reflected frequency of the R12-X may be higher or lower than 2.4 GHz depending on a magnitude of motion of the user 108. More specifically, assume that the sensor S12 (such as a passive wireless sensor at a second known location) detects that the reflected wireless signal R12-X is received at time T24 and is received at a frequency of FREQ1+delta DX2 (delta DX2 represents a difference or frequency shift with respect to FREQ1, signal R12-X has a different frequency than FREQ1 due to doppler shift caused by movement of user 108).

The third portion of the transmitted wireless signal M1-X reflects off the user 108 at time T22. For example, a portion of the transmitted wireless signal M1-X reflects off the user 108 (person) as reflected signal R13-X to the sensor S13. Depending upon the motion associated with the user 108, the reflected wireless signal R13-X has a different frequency than the original frequency FREQ1 of the signal M1-X. In other words, the reflected frequency of the R13-X may be higher or lower than 2.4 GHz depending on a magnitude of motion of the user 108. More specifically, assume that the sensor S13 (such as a passive wireless sensor at a third known location in region 121) detects that the reflected wireless signal R13-X is received at time T25 and is received at a frequency of FREQ1+delta DX3 (delta DX3 represents a difference or frequency shift with respect to FREQ1 signal, and R13-X has a different frequency than FREQ1 due to doppler shift caused by movement of user 108).

As previously discussed, each of the sensors communicates the respective feedback (such as frequency information of the received reflection signal and a timing of receiving the reflected wireless signal) associated with monitoring the reflected wireless signals to the management entity 140. The management entity 140 stores the above feedback as monitor information 151-X for each of the different monitored motions of the user 108 over time as monitor information 151. As previously discussed, the management entity 140 collects the monitor information 151-X for each time sample value X, where X is any time value.

More specifically, as further discussed herein, for X=11, the management entity 140 stores timing and frequency received from the sensors 131, 132, and 133 as monitor information 151-X for time T11. Thus, for a transmitted signal M1-11 at time X=11, the management entity 140 stores corresponding timing and frequency (associated with reflected signals R11-11, R12-11, and R13-11) as generated by the sensors 131, 132, and 133 as monitor information 151-11 (which encodes a motion/gesture/expression/etc. associated with the user 108 at time T11); for a transmitted signal M1-21 at time TX=T21, the management entity 140 stores corresponding timing and frequency (associated with reflected signals R11-21, R12-21, and R13-21) as generated by the sensors 131, 132, and 133 as monitor information 151-21 (which encodes a motion/gesture/expression/etc. associated with the user 108 at time T21); for a transmitted signal M1-31 at time TX=T31, the management entity 140 stores corresponding timing and frequency (associated with reflected signals R11-31, R12-31, and R13-31) as generated by the sensors 131, 132, and 133 as monitor information 151-31 (which encodes a motion/gesture/expression/etc. associated with the user 108 at time T31); for a transmitted signal M1-41 at time TX=T41, the management entity 140 stores corresponding timing and frequency (associated with reflected signals R11-41, R12-41, and R13-41) as generated by the sensors 131, 132, and 133 as monitor information 151-41 (which encodes a motion/gesture/expression/etc. associated with the user 108 at time T41); for a transmitted signal M1-51 at time TX=T51, the management entity 140 stores corresponding timing and frequency (associated with reflected signals R11-51, R12-51, and R13-51) as generated by the sensors 131, 132, and 133 as monitor information 151-51 (which encodes a motion/gesture/expression/etc. associated with the user 108 at time T51); for a transmitted signal M1-61 at time TX=T61, the management entity 140 stores corresponding timing and frequency (associated with reflected signals R11-61, R12-61, and R13-61) as generated by the sensors 131, 132, and 133 as monitor information 151-61 (which encodes a motion/gesture/expression/etc. associated with the user 108 at time T61); for a transmitted signal M1-71 at time TX=T71, the management entity 140 stores corresponding timing and frequency (associated with reflected signals R11-71, R12-71, and R13-71) as generated by the sensors 131, 132, and 133 as monitor information 151-71 (which encodes a motion/gesture/expression/etc. associated with the user 108 at time T71); for a transmitted signal M1-81 at time TX=T81, the management entity 140 stores corresponding timing and frequency (associated with reflected signals R11-81, R12-81, and R13-81) as generated by the sensors 131, 132, and 133 as monitor information 151-81 (which encodes a motion/gesture/expression/etc. associated with the user 108 at time T81); for a transmitted signal M1-91 at time TX=T91, the management entity 140 stores corresponding timing and frequency (associated with reflected signals R11-91, R12-91, and R13-91) as generated by the sensors 131, 132, and 133 as monitor information 151-91 (which encodes a motion/gesture/expression/etc. associated with the user 108 at time T91); and so on.

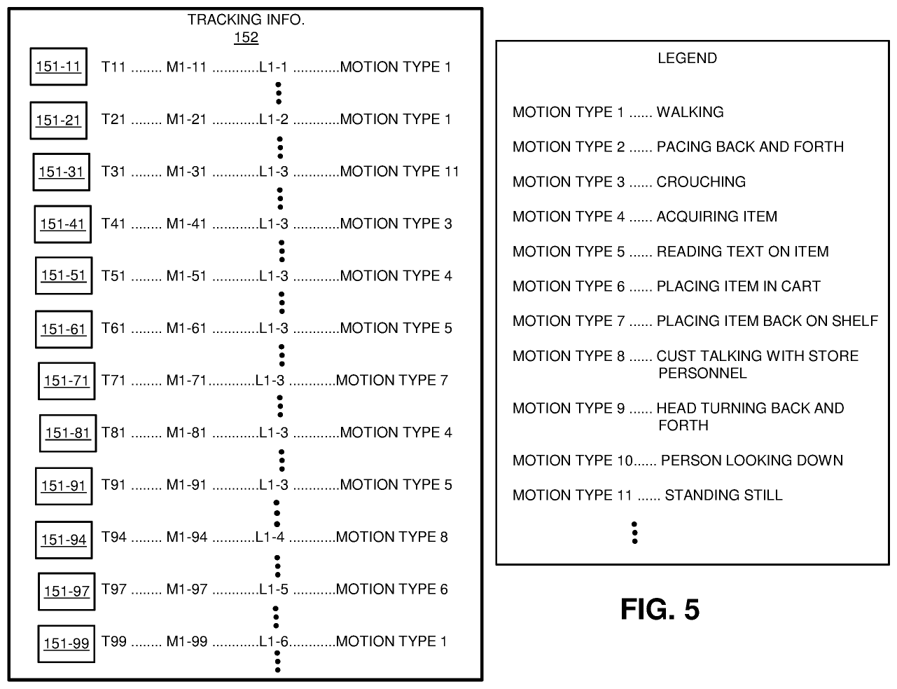

The analyzer entity 141 derives tracking information 152 at least in part in via application of the learned signature information 153. For example, for each time frame or sample time of receiving respective feedback and generating monitor information 151-11 . . . , monitor information 151-21, . . . , monitor information 151-31 . . . , monitor information 151-91 . . . , from sensors S11, S12, and S13 and monitoring motion of the respective user 108, the analyzer entity 141 maps respective received feedback (set of monitor information 151-X such as a signature of signals illustrated in FIG. 2) to a corresponding motion type associated with the user 108. An example of tracking information 152 is shown in FIG. 5.

Referring again to FIG. 3, the analyzer entity 141 can be configured to determine a location of the user at different times based on time of flight algorithms. For example, it is known at what time the wireless signal M1-X is transmitted in the region 121. The location of sensors S11, S12, and S13 receiving reflected signals R11-X, R12-X, and R13-X is also known. Via triangulation, and time of flight associated with the transmitted signal M1-X and the reflected signals R11-X, R12-X. and R13-X, the analyzer entity 141 as discussed herein determines the respective location of the user 108 at each sample time X.

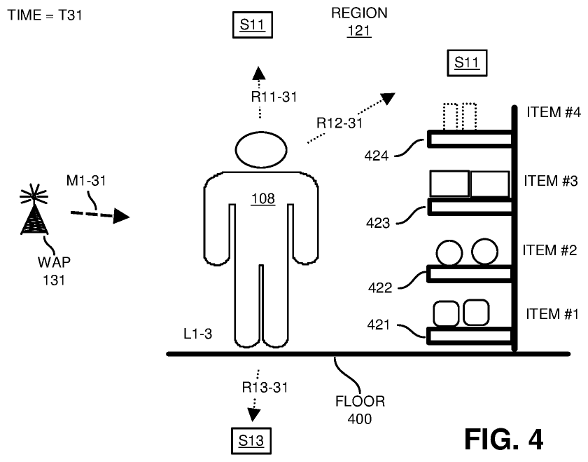

FIG. 4 is an example diagram illustrating monitoring of a respective user in a retail environment as described herein.

As previously discussed, the management entity 141 receives feedback associated with reflected wireless signals over time as the user is present in the region 121.

In this example, assume that the region 121 includes multiple shelves such as shelf 421 on which items of type #1 reside, shelf 422 on which items of type #2 reside, shelf 423 on which items of type #3 reside, shelf 424 on which items of type #4 reside, and so on. The shelves and corresponding items reside at location L11 in the region 121.

As further shown, at or around time T31, the management entity 140 causes the wireless access point 131 to transmit wireless signals M1-31. As previously discussed, the wireless access point 131 transmits wireless signals M1-31. Each of the sensors receives respective reflected portions R11-31, R12-31, and R13-31 for monitored motion of the user 108 at time T31.

As further discussed below, the analyzer entity 141 uses the monitor information 151 as a basis to produce tracking information 152 indicating different motions (such as gestures) of the user 108 in the region 121 over time.

FIG. 5 is an example diagram illustrating generated tracking information indicating the detected movement associated with a person in a retail environment as described herein.

In this example, the analyzer entity 141 derives the tracking information 152 based on the samples of monitor information 151 associated with the user 108. For example, as previously discussed, the analyzer entity 141 analyzes the frequency and timing information associated with the received monitor information 151-11 to produce tracking information 152.

More specifically, for time T11, the analyzer entity 141 determines that the frequency information and timing information associated with the reflected wireless signals R11, R12, and R13 as captured in monitor information 151-11 corresponds to a signature of motion type #1 (such as user 108 walking) and that the user 108 was at location L1-1 in region 121 at or around time T11.

For time T21, the analyzer entity 141 determines that the frequency information and timing information associated with the reflected wireless signals R11, R12, and R13 as captured in monitor information 151-21 corresponds to a signature of motion type #1 (such as user 108 walking) and that the user 108 was at location L1-2 in region 121 at or around time T21.

For time T31, the analyzer entity 141 determines that the frequency information and timing information associated with the reflected wireless signals R11, R12, and R13 as captured in monitor information 151-31 corresponds to a signature of motion type #11 (such as user standing still) and that the user 108 was at location L1-3 in region 121 at or around time T31.

For time T41, the analyzer entity 141 determines that the frequency information and timing information associated with the reflected wireless signals R11, R12, and R13 as captured in monitor information 151-41 corresponds to a signature of motion type #3 (such as user crouching or bending over) and that the user 108 was at location L1-3 in region 121 at or around time T41.

For time T51, the analyzer entity 141 determines that the frequency information and timing information associated with the reflected wireless signals R11, R12, and R13 as captured in monitor information 151-51 corresponds to a signature of motion type #4 (such as user acquiring an item #2 from shelf 422) and that the user 108 was at location L1-3 in region 121 at or around time T51.

For time T61, the analyzer entity 141 determines that the frequency information and timing information associated with the reflected wireless signals R11, R12, and R13 as captured in monitor information 151-61 corresponds to a signature of motion type #5 (such as user reading text on the item #2) and that the user 108 was at location L1-3 in region 121 at or around time T61.

For time T71, the analyzer entity 141 determines that the frequency information and timing information associated with the reflected wireless signals R11, R12, and R13 as captured in monitor information 151-71 corresponds to a signature of motion type #7 (such as user placing item #2 back on shelf 422) and that the user 108 was at location L1-3 in region 121 at or around time T71.

For time T81, the analyzer entity 141 determines that the frequency information and timing information associated with the reflected wireless signals R11, R12, and R13 as captured in monitor information 151-81 corresponds to a signature of motion type #4 (such as user acquiring item #4 on shelf 424) and that the user 108 was at location L1-3 in region 121 at or around time T81.

For time T91, the analyzer entity 141 determines that the frequency information and timing information associated with the reflected wireless signals R11, R12, and R13 as captured in monitor information 151-91 corresponds to a signature of motion type #5 (such as user reading text on acquired item #4) and that the user 108 was at location L1-3 in region 121 at or around time T91.

For time T94, the analyzer entity 141 determines that the frequency information and timing information associated with the reflected wireless signals R11, R12, and R13 as captured in monitor information 151-94 corresponds to a signature of motion type #8 (such as user speaking with store personnel) and that the user 108 was at location L1-4 in region 121 at or around time T94.

For time T97, the analyzer entity 141 determines that the frequency information associated with the reflected wireless signals R11, R12, and R13 as captured in monitor information 151-97 corresponds to a signature of motion type #6 (such as placing acquired item #4 in the user's cart) and that the user 108 was at location L1-5 in region 121 at or around time T97.

For time T99, the analyzer entity 141 determines that the frequency information and timing information associated with the reflected wireless signals R11, R12, and R13 as captured in monitor information 151-99 corresponds to a signature of motion type #1 (such as placing acquired item #4 in the user's cart) and that the user 108 was at location L1-6 in region 121 at or around time T98.

Accordingly, the monitor information 152 provides a history of events and behavior associated with the user 108 moving through the region 121.

Note that the tracking information 152 can be used for any suitable purpose. For example, the tracking information 152 (user selecting item #2 and placing it back on shelf and then purchasing the competitor item #4 instead) may indicate that the label of the item #2 was not as appealing as the label on item #4. Detected motion of the user 108 pacing back and forth may indicate that the user 108 was unable to find an item of interest.

Based on monitor information and tracking information associated with each of multiple different users, the analyzer entity 141 can be configured to identify trends such as that customers prefer the item #2 over item #4. Detected motion of the multiple users pacing back and forth in a particular location and then selecting the same item (such as item #3) for purchase may indicate that the customers in general are unable to easily find the item #3. This may indicate that the packaging associated with item #3 may need to be changed, and so on.

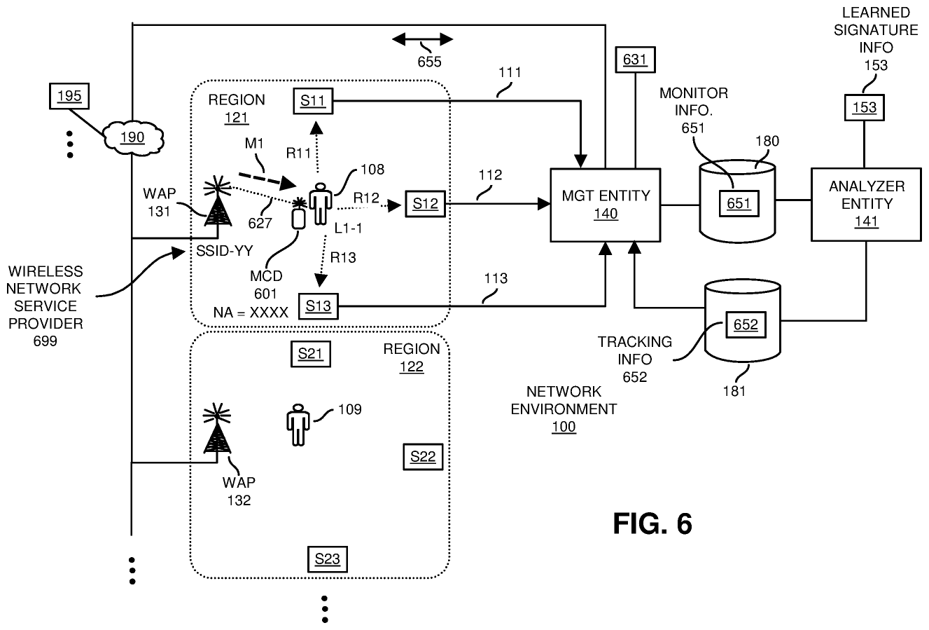

FIG. 6 is an example diagram illustrating a network environment and implementation of motion-gesture monitoring associated with a user of a mobile communication device as described herein.

In this example, assume that the user 108 and corresponding communication device 601 subscribe to a wireless network service provider 699 supporting wireless network service SSID-YY through the wireless access point 131. The wireless network service associated with the wireless network service provider 699 enables a respective mobile communication device to communicate through the wireless access point 131 to the remote network 190 corresponding servers. Assume further that the mobile communication device 601 (a.k.a., user equipment) operated by the user 108 is configured to automatically connect to a respective wireless network associated with the wireless network service provider 699 when in a vicinity of a wireless access point supporting the wireless network service SSID-YY. In other words, if the mobile communication device 601 detects presence of a wireless access point providing service associated with the network name SSID-YY, the mobile communication device attaches to that wireless access point to use the corresponding provided services associated with wireless network SSID-YY.

As further shown in this example, the wireless access point 131 wirelessly broadcasts notifications in the region 121. The broadcast notifications indicate availability of a wireless network service SSID-YY (a.k.a., a network name or network identifier value) for use by any listening subscribers that are subscribers of the wireless network service provider 699.

In response to the mobile communication device 601 receiving notification of the availability of wireless network SSID-YY provided by the wireless network service provider 699 through the wireless access point 131, the mobile communication device 601 establishes a wireless communication link 627 with the wireless access point 131 to use wireless services associated with the wireless network service SSID-YY. When establishing the wireless communication link 627, such as during association and/or authentication, via communications from the mobile communication device 601 to the wireless access point 131, the wireless access point 131 learns of the network address XXXX assigned to the mobile communication device 601. Via the wireless communication link 627, the mobile communication device 601 has access to the network 190.

Via communications 655, the wireless access point 131 can be configured to communicate the network address XXXX associated with the mobile communication device 601 to the management entity 140. Based on the network address XXXX, the management entity 140 determines a respective identity of the user 108 and potentially provides services such as navigation guidance to the user 108 operating the mobile communication device 601.

In a similar manner as previously discussed, the management entity 140 can be configured to monitor motion and/or gestures associated with one or more persons disposed in each of the different regions 121, 122, etc. For example, as shown, the region 121 includes wireless access point 131. The wireless access point 131 provides one or more mobile communication devices (including mobile communication device 601) in the region 121 wireless access through the wireless access point 131 to the network 190 such as the Internet. In other words, as previously discussed, via the wireless communication link 627, the mobile communication device 601 is able to communicate through wireless access point 131 or to the network 190.

In addition to providing the one or more mobile communication devices access to the wireless access point 131 to the network 190, the wireless access point 131 can be configured to transmit wireless signals M1 in the region 121 of network environment 100 to wirelessly monitor behavior of the user 108 operating the mobile communication device 601. Via the wireless signals M1 transmitted from the wireless access point 131, the management entity 140 detects presence of one or more persons in the region 121 of the network environment 100.

Note that the wireless signals M1 may or may not include data communicated to a specific target (such as communication device 601) in the network environment 100. In other words, the wireless signals M1 can be configured to include a data payload transmitted from the wireless access point 131 to the mobile communication device 601. The corresponding packets carrying the data payload can include a respective network address XXXX specifying the mobile communication device 601 as the intended recipient.

In one example, the management entity 140 initiates transmission of the wireless signals M1 from the wireless access point 131 in the region 121 in response to receiving one or more control signals from the management entity 140 to the wireless access point 131. In other words, the management entity 140 can be configured to control communications such as wireless signals M1 and or other communications from the wireless access point 131 to the mobile communication device 601.

As further shown, and as previously discussed, the region 121 includes one or more sensors S11, S12, S13, etc., to monitor reflections of the wireless signals M1 transmitted by the wireless access point 131. The management entity 140 can be configured to control operation of the sensors S11, S12, S13, etc., in order to monitor one or more users in the region 121.

In this example, portions of the wireless signals M1 transmitted from the wireless access point 131 are reflected off the user 108 as wireless signals R11, R12, R13, etc. A respective sensor converts a respective received reflected wireless signal into an electrical signal and provides notification of the detected/reflected signal and/or its attributes (such as wireless frequency of the reflected signal, an exact time of receiving the reflected signal, etc.) to the management entity 140.

More specifically, in this example, via management entity 140, each of the sensors S11, S12, S13, etc., and wireless access point 131 can be synchronized to a common master clock. The sensor S11 receives reflected wireless signal R11 (such as a first portion of wireless energy associated with the wireless signals M1 transmitted by the wireless access point 131); the sensor S11 determines attributes (such as time of receipt, frequency information, etc.) of the reflected wireless signal R11 and communicates them to the management entity 140. The sensor S12 receives reflected wireless signal R12 (such as a second portion of wireless energy associated with the wireless signals M1 transmitted by the wireless access point 131); the sensor S12 determines attributes (such as time of receipt, frequency information, etc.) of the reflected wireless signal R12 and communicates them to the management entity 140. The sensor S13 receives reflected wireless signal (such as a first portion of wireless energy associated with the wireless signals M1 transmitted by the wireless access point 131); the sensor S13 determines attributes (such as time of receipt, frequency information, etc.) of the reflected wireless signal R13 and communicates them to the management entity 140.

As previously discussed, the analyzer entity 141 converts the monitor information 651 (such as raw location and motion information) into tracking information 652. This can occur in substantially real-time such that the management entity 140 is able to determine the current location and the type of most recent motion of the user 108 over time. In such an instance, the management entity 140 can be configured to provide immediate feedback to user 108 via a display screen of the mobile communication device 601.

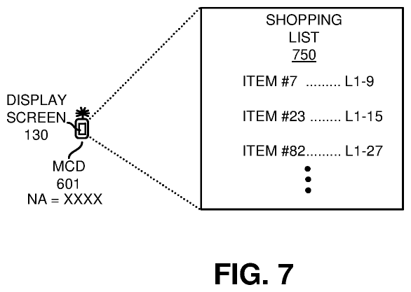

FIG. 7 is an example diagram illustrating implementation of a respective display screen on a mobile communication device to display desired items for purchase in a retail environment as described herein.

As further shown in this example, the mobile communication device 601 can be configured to include a respective shopping list 750 presented for display on display screen 130. The shopping list indicates one or more items of interest to the user 108. For example, the shopping list 750 indicates that the user 108 is interested in purchasing item #7, item #23, item #82, etc. as discussed below, the management entity 140 can be configured to provide location information indicating the location of each of the items in the region 121.

Referring again to FIG. 6, mobile communication device 601 can be configured to communicate the shopping list 750 through the wireless access point 131 and network 190 to the management entity 140 or other suitable resource. The management entity 140 has access to mapping information 631 indicating respective locations of each of the items in the shopping list 750.

Via the mapping information 631, the management entity 140 determines that: i) item #7 resides at location L91 in the region 121, ii) item #23 resides at location L53, iii) item #82 resides at location L26, and so on.

The management entity 140 can be configured to initiate communications through the wireless access point 131 to the mobile communication device 601 indicating the location of each of the respective items on the shopping list 750 as the user passes through the region 121. For example, via wireless communications from the wireless access point 131, the management entity 140 can be configured to notify the corresponding user 108 that: i) the item #7 resides at location L1-9 (such as aisle 1, bay 9), ii) the item #22 resides at location L1-15 (such as aisle 1, bay 15), iii) the item #82 resides at location L1-27 (such as aisle 1, bay 27), etc.

As previously discussed, the management entity 140 can be configured to monitor a location and/or behavior such as motion/gestures associated with the user 108 operating the mobile communication device 601 as the corresponding user 108 navigates the region 121 (such as a retail environment). For example, over time, the wireless access point 131 transmits instances of the wireless signals M1 such as wireless signal M1-111 at time T111, wireless signal M1-112 at time T112, . . . , wireless signal M1-121 at time T121, wireless signal M1-122 at time T122, . . . , wireless signal M1-131 at time T131, wireless signal M1-132 at time T132, . . . , wireless signal M1-141 at time T141, wireless signal M1-142 at time T142, . . . , wireless signal M1-151 at time T151, wireless signal M1-152 at time T152, . . . , wireless signal M1-161 at time T161, wireless signal M1-162 at time T162, . . . , wireless signal M1-171 at time T171, wireless signal M1-172 at time T172, . . . wireless signal M1-181 at time T181, wireless signal M1-182 at time T182, . . . , and so on.

As previously discussed, for each instance of transmitted wireless signal M1, the management entity 140 receives corresponding feedback (such as signature of motion and corresponding location of the user 108) from the one or more sensors and stores it as monitor information 151 (such as signature and location of respective detected motion) in repository 180.

For example, for each sample value X, where X is any integer value 1, 2, 3, . . . , 99, 100 . . . , for transmitted wireless signal M1-X, the management entity 140 receives and produces monitor information 151 (including a signature of Doppler/frequency information capturing corresponding to detected motion) to include: i) feedback 111 from the sensor S11 indicating an absolute time of receiving the reflected wireless signal R11-X (portion of wireless signal M1-X reflected off the user 108 to the sensor S11) as well as a magnitude of the frequency and/or frequency shift associated with the reflected wireless signal R11-X; ii) feedback 112 from the sensor S12 indicating a time of receiving the reflected wireless signal R12-X (portion of wireless signal M1-X reflected off the user 108 to the sensor S12) as well as a magnitude of the frequency and/or frequency shift associated with the reflected wireless signal R12-X; iii) feedback 111 from the sensor S13 indicating a time of receiving the reflected wireless signal R13-X (portion of wireless signal M1-X reflected off the user 108 to the sensor S13) as well as a magnitude of the frequency and/or frequency shift associated with the reflected wireless signal R13-X; and so on.

As previously discussed, the wireless signal M1 can be transmitted the frequency FREQ1. The frequency and/or frequency shift information in the monitor information 651 indicates the difference between the frequency of the received reflected signal with respect to the original frequency FREQ1.

As further shown, the analyzer entity 141 converts the received (collected) monitor information 151 into tracking information 152. The tracking information 152 indicates attributes such as location and/or behavior such as motion, gestures, expression, etc., of the user 108 as determined from the monitor information 151.

In accordance with further examples as shown in FIG. 2, the management entity 140 and analyzer entity 141 can be configured to learn a signature (such as based on one or more frequency shifts of an original wireless signal M1 transmitted by the wireless access point 131) received at each of the sensors for different types of motions, gestures, expressions, etc., of any person in the network environment 100. This can include a test person performing a respective desired motion or gesture (test condition) and analyzing the corresponding feedback generated by the sensors for each respective test motion/gesture. Other persons performing the same motion results in the sensors producing the same or similar feedback as the test condition.

The management entity 140 or other suitable entity stores the learned signature information 153 including learned different types of feedback received from the sensors for different detected motions, gestures, expression, etc., in the network environment.

In one example, the signature information 153 includes a collection of multiple different feedback entries for each of multiple different types of movement/expression/etc., enabling the analyzer entity 141 to map a collection or set of received feedback information (based on reflections R11, R12, R13, etc.) for each wireless signal M1 to a corresponding type of detected motion, gesture, expression, etc., associated with the user 108. Based on the detected type of movement/expression/etc. of one or more person in the network environment 100, the analyzer entity 141 or other suitable entity can be configured to perform functions such as i) determine a better layout of shelving items in a retail environment, ii) learn about reactions of customers viewing an item for sale, iii) provide better guidance to the user to find different products in the retail environment, etc.

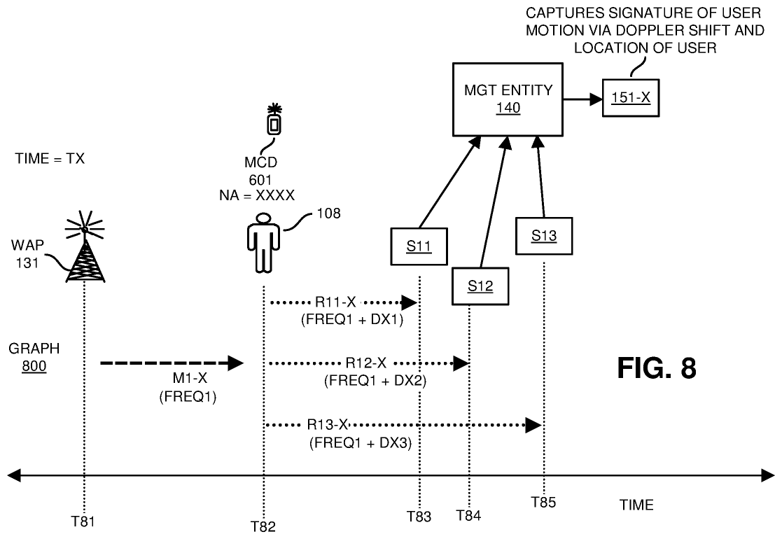

As shown in FIG. 8, in addition to the timing information to determine motion of the user 108, the analyzer entity 141 also uses the monitor information 151 to determine a respective location of the user 108 over time.

FIG. 8 is an example diagram illustrating transmission of wireless signals from a wireless access point and corresponding wireless signal reflections off an object (such as a person) to one or more sensors as described herein.

Graph 800 illustrates transmission of a respective wireless signal M1-X (such as one or more wireless signals) from the wireless access point 131 for time TX. As previously discussed, it is known at what time (such as T81 or other suitable value) the wireless signal M1-X is transmitted from the wireless access point 131. The wireless signal M1-X is transmitted at a known frequency of FREQ1.

The frequency FREQ1 of transmitting wireless signal M1-X can be any suitable frequency. The frequency may any value such as 2.4 GHz, 5 GHZ, 6.1 GHZ, etc.

As previously discussed, the first portion of the transmitted wireless signal M1-X reflects off the user 108 at time T82 as reflection R11-X. For example, a portion of the transmitted wireless signal M1-X (such as 2.4 GHz) reflects off the user 108 (person) as reflected signal R11-X to the sensor S11. Depending upon the motion associated with the user 108, the reflected wireless signal R11-X has a different frequency profile than the original frequency FREQ1 of the signal M1-X. In other words, the reflected frequency of the R11-X may be the same, higher, or lower than FREQ1 or 2.4 GHZ depending on a magnitude of motion of the user 108. More specifically, assume that the sensor S11 (such as a passive wireless sensor at a first known location in region 121) detects that the reflected wireless signal R11-X is received at time T83 and is received at a frequency of FREQ1+delta DX1 (signal R11-X has a different frequency than FREQ1 due to doppler shift caused by movement of user 108).

A second portion of the transmitted wireless signal M1-X reflects off the user 108 at time T82. For example, a portion of the transmitted wireless signal M1-X reflects off the user 108 (person) as reflected signal R12-X to the sensor S12. Depending upon the motion associated with the user 108, the reflected wireless signal R12-X has a different frequency than the original frequency FREQ1 of the signal M1-X. In other words, the reflected frequency of the R12-X may be the same, higher, or lower than FREQ1 or 2.4 GHz depending on a magnitude of motion of the user 108. More specifically, assume that the sensor S12 (such as a passive wireless sensor at a second known location) detects that the reflected wireless signal R12-X is received at time T84 and is received at a frequency of FREQ1+delta DX2 (signal R12-X has a different frequency than FREQ1 due to doppler shift caused by movement of user 108).

The third portion of the transmitted wireless signal M1-X reflects off the user 108 at time T22. For example, a portion of the transmitted wireless signal M1-X reflects off the user 108 (person) as reflected signal R13-X to the sensor S13. Depending upon the motion associated with the user 108, the reflected wireless signal R13-X has a different frequency than the original frequency FREQ1 of the signal M1-X. In other words, the reflected frequency of the R13-X may be higher or lower than FREQ1 or 2.4 GHz depending on a magnitude of motion of the user 108. More specifically, assume that the sensor S13 (such as a passive wireless sensor at a third known location in region 121) detects that the reflected wireless signal R13-X is received at time T85 and is received at a frequency of FREQ1+delta DX3 (signal R13-X has a different frequency than FREQ1 due to doppler shift caused by movement of user 108).

As previously discussed, each of the sensors communicates the respective feedback (such as frequency information of the received reflection signal and a timing of receiving the reflected wireless signal) associated with monitoring the reflected wireless signals to the management entity 140. The management entity 140 stores the above feedback as monitor information 151-X for each of the different monitored motions of the user 108 over time as monitor information 151. As previously discussed, the management entity 140 collects the monitor information 151-X for each time sample value X, where X is any time value.

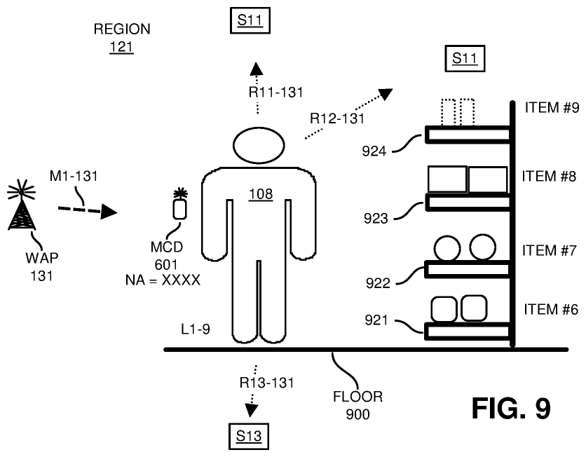

FIG. 9 is an example diagram illustrating monitoring of a respective user in a retail environment as described herein.

As previously discussed, the management entity 140 receives feedback associated with reflected wireless signals over time as the user is present in the region 121.

In this example, assume that the location L1-9 in region 121 includes multiple shelves such as shelf 921 on which items of type #6 reside, shelf 922 on which items of type #7 reside, shelf 923 on which items of type #8 reside, shelf 924 on which items of type #9 reside, and so on. The shelves and corresponding items reside at location L1-9 in the region 121.

As further shown, at or around time T131, the management entity 140 causes the wireless access point 131 to transmit wireless signals M1-131. As previously discussed, the wireless access point 131 transmits wireless signals M1-131. Each of the sensors receives respective reflected portions R11-131, R12-131, and R13-131 for monitored motion of the user 108 at time T131. In this example, the received feedback from the sensors S11, S12, S13, etc., associated with time T131 indicates that the user 108 is standing still at location L1-9.

As further discussed below, the analyzer entity 141 uses the monitor information 651 as a basis to produce tracking information 652 indicating different motions (such as gestures) of the user 108 in the region 121 over time such as while the management entity 140 or other suitable entity provides navigation instructions (how to navigate about region 121) to the mobile communication device 601 and corresponding user 108.

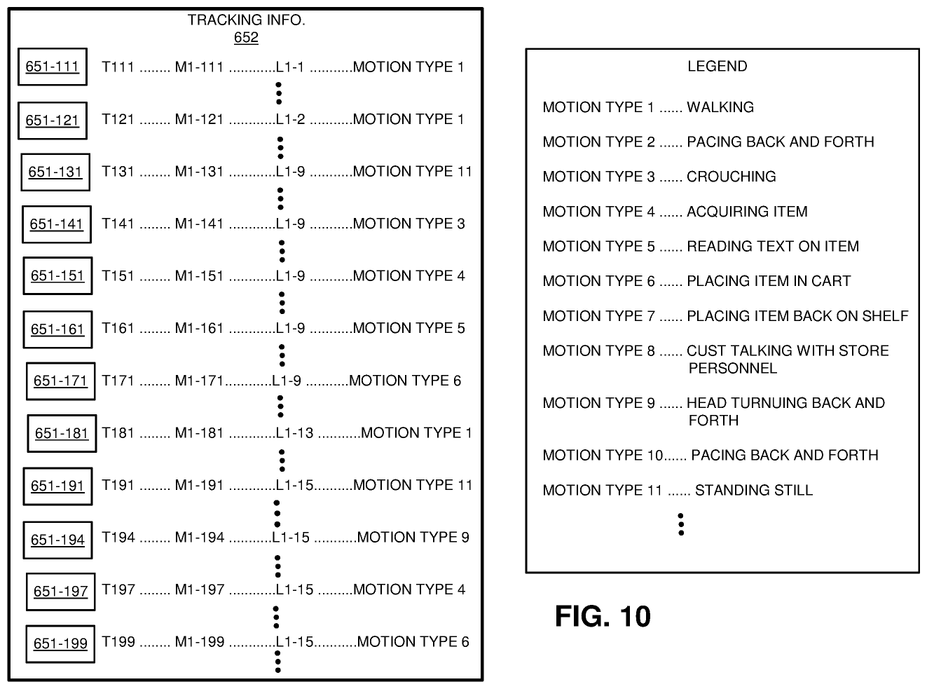

FIG. 10 is an example diagram illustrating generated monitor information indicating detected movement associated with a person in a retail environment as described herein.

In this example, the analyzer entity 141 derives the monitor information 652 based on the samples of tracking information 651 associated with the user 108. For example, as previously discussed, the analyzer entity 141 analyzes the frequency and timing information associated with the received monitor information 651 to produce tracking information 652.

More specifically, for time T111, the analyzer entity 141 determines that the frequency information and timing information associated with the reflected wireless signals R11, R12, and R13 in monitor information 651-11 corresponds to a signature of motion type #1 (such as user 108 walking) and that the user 108 was at location L1-1 in region 121 at or around time T111.

For time T121, the analyzer entity 141 determines that the frequency information and timing information associated with the reflected wireless signals R11, R12, and R13 in monitor information 651-121 corresponds to a signature of motion type #1 (such as user 108 walking) and that the user 108 was at location L1-2 in region 121 at or around time T121.

For time T131, the analyzer entity 141 determines that the frequency information and timing information associated with the reflected wireless signals R11, R12, and R13 in monitor information 651-131 corresponds to a signature of motion type #11 (such as user standing still) and that the user 108 was at location L1-9 in region 121 at or around time T131.

For time T141, the analyzer entity 141 determines that the frequency information and timing information associated with the reflected wireless signals R11, R12, and R13 in monitor information 651-141 corresponds to a signature of motion type #3 (such as user crouching) and that the user 108 was at location L1-9 in region 121 at or around time T141.

For time T151, the analyzer entity 141 determines that the frequency information and timing information associated with the reflected wireless signals R11, R12, and R13 in monitor information 651-151 corresponds to a signature of motion type #4 (such as user acquiring an item #7 from shelf 922) and that the user 108 was at location L1-9 in region 121 at or around time T151.

For time T161, the analyzer entity 141 determines that the frequency information and timing information associated with the reflected wireless signals R11, R12, and R13 in monitor information 651-61 corresponds to a signature of motion type #5 (such as user reading text on the selected item #7) and that the user 108 was at location L1-9 in region 121 at or around time T161.

For time T171, the analyzer entity 141 determines that the frequency information and timing information associated with the reflected wireless signals R11, R12, and R13 in monitor information 651-171 corresponds to a signature of motion type #6 (such as user placing item #7 in the user's cart) and that the user 108 was at location L1-9 in region 121 at or around time T171.

In response to detecting that the user 108 has placed the item #7 in his cart (such as shopping basket), the management entity 140 can be configured to provide navigation information through the wireless access point 131 over the wireless communication link 627 to the mobile communication device 601 and corresponding user 108. The navigation information can indicate a location L1-15 where the next item #23 on the list is located in the region 121. The navigation information can be: i) map information displayed on the display screen 130 of the mobile communication device 601, ii) an audio signal played back by the mobile communication device 601 to the user 108 indicating a location of the next item on the list, etc. Accordingly, the management entity 140 can be configured to provide real-time or near real-time navigations instructions to the user 108 in the network environment based on the respective monitor information.

For time T181, the analyzer entity 141 determines that the frequency information and timing information associated with the reflected wireless signals R11, R12, and R13 in monitor information 651-181 corresponds to a signature of motion type #1 (such as user walking) and that the user 108 was at location L1-13 in region 121 at or around time T181.

For time T191, the analyzer entity 141 determines that the frequency information and timing information associated with the reflected wireless signals R11, R12, and R13 in monitor information 651-191 corresponds to a signature of motion type #11 (such as user standing still) and that the user 108 was at location L1-15 in region 121 at or around time T191.

For time T194, the analyzer entity 141 determines that the frequency information and timing information associated with the reflected wireless signals R11, R12, and R13 in monitor information 651-194 corresponds to a signature of motion type #9 (such as user head turning back and forth) and that the user 108 was at location L1-15 in region 121 at or around time T194.

For time T197, the analyzer entity 141 determines that the frequency information associated with the reflected wireless signals R11, R12, and R13 in monitor information 651-197 corresponds to a signature of motion type #4 (such as placing acquired item #23 in the user's cart) and that the user 108 was at location L1-15 in region 121 at or around time T197.

For time T199, the analyzer entity 141 determines that the frequency information and timing information associated with the reflected wireless signals R11, R12, and R13 in monitor information 651-199 corresponds to a signature of motion type #1 (such as placing acquired item #23 in the user's cart) and that the user 108 was at location L1-15 in region 121 at or around time T199.

In response to detecting that the user 108 has placed the item #23 in his cart (such as shopping basket), the management entity 140 can be configured to provide navigation information through the wireless access point 131 over the wireless communication link 627 to the mobile communication device 601 and corresponding user 108. The navigation information can indicate a location L1-27 where the next item #82 on the list is located in the region 121. The navigation information can be: i) map information displayed on the display screen 130 of the mobile communication device 601, ii) an audio signal played back by the mobile communication device 601 to the user 108 indicating a location of the next item on the list, etc.

Accordingly, the tracking information 652 provides a history of events (behavior) associated with the user 108 moving through the region 121.

Based on monitor information and tracking information associated with each of multiple different users, the analyzer entity 141 can be configured to identify trends such as that customers prefer one item over another. As previously discussed, detected motion of the multiple users pacing back and forth in a particular location and then selecting the same item (such as item #3) for purchase may indicate that the customers in general are unable to easily find the item #3. This may indicate that the packaging associated with item #3 may need to be changed, and so on.

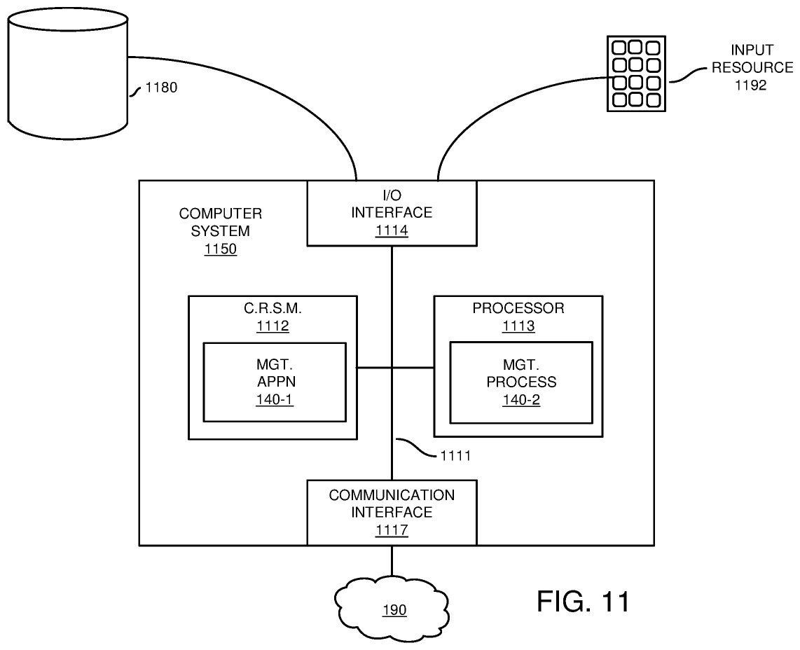

FIG. 11 is an example block diagram of a computer system for implementing any of the operations as previously discussed according to embodiments herein.

Note that any of the resources as discussed herein can be configured to include computer processor hardware and/or corresponding executable instructions to carry out the different operations as discussed herein.

For example, as shown, computer system 1150 of the present example includes interconnect 1111 coupling computer readable storage media 1112 such as a non-transitory type of media (which can be any suitable type of hardware storage medium in which digital information can be stored and or retrieved), a processor 1113 (computer processor hardware), I/O interface 1114, and a communications interface 1117.

I/O interface(s) 1114 supports connectivity to repository 1180 and input resource 1192.

Computer readable storage medium 1112 can be any hardware storage device such as memory, optical storage, hard drive, floppy disk, etc. In one embodiment, the computer readable storage medium 1112 stores instructions and/or data.

As shown, computer readable storage media 1112 can be encoded with management application 140-1 (e.g., including instructions associated with any entity as discussed herein) in a respective wireless station to carry out any of the operations as discussed herein.

During operation of one embodiment, processor 1113 accesses computer readable storage media 1112 via the use of interconnect 1111 in order to launch, run, execute, interpret or otherwise perform the instructions in management application 140-1 stored on computer readable storage medium 1112. Execution of the management application 140-1 produces management process 140-2 to carry out any of the operations and/or processes as discussed herein.

Those skilled in the art will understand that the computer system 1150 can include other processes and/or software and hardware components, such as an operating system that controls allocation and use of hardware resources to execute the management application 140-1.

In accordance with different embodiments, note that computer system may reside in any of various types of devices, including, but not limited to, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 1150 may reside at any location or can be included in any suitable resource in any network environment to implement functionality as discussed herein.

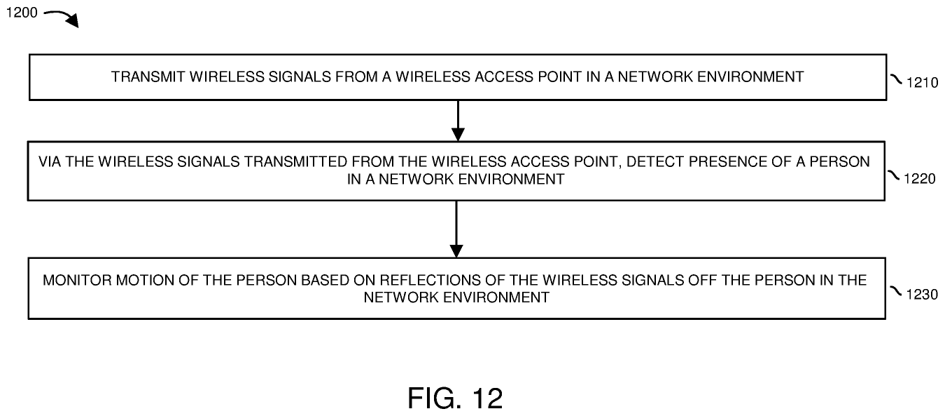

Functionality supported by the different resources will now be discussed via flowcharts in FIG. 12. Note that the steps in the flowcharts below can be executed in any suitable order.

FIG. 12 is a flowchart 1200 illustrating an example method according to embodiments herein. Note that there will be some overlap with respect to concepts as discussed above.

In processing operation 1210, the monitor system initiates transmission of wireless signals from a wireless access point in a network environment.

In processing operation 1220, via the wireless signals transmitted from the wireless access point, the monitor system detects presence of a person in a network environment.

In processing operation 1230, the monitor system monitors motion of the person based on reflections of the wireless signals off the person in the network environment.

Note again that techniques herein are well suited to facilitate wireless connectivity in accordance with different available wireless services. However, it should be noted that embodiments herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

We claim:

1. A method comprising:
transmitting wireless signals from a wireless access point in a network environment, the wireless access point providing wireless access to a remote network;
via the wireless signals transmitted from the wireless access point, detecting presence of a person in a network environment; and
monitoring motion of the person based on reflections of the wireless signals off the person in the network environment.

2. The method as in claim 1, wherein monitoring the motion of the person includes:
determining a location of the person in the network environment based on reception of the wireless signals at multiple different wireless sensors in the network environment.

3. The method as in claim 1, wherein monitoring the motion of the person includes:
monitoring browsing activity of the person viewing products available for selection from a shelf in the network environment.

4. The method as in claim 1, wherein monitoring the motion of the person includes:
detecting the person acquiring an item.

5. The method as in claim 1, wherein the wireless signals include a first wireless signal transmitted from the wireless access point; and
wherein monitoring the motion of the person includes: i) receiving a first reflection of the first wireless signal off the person, and ii) mapping a signature of the first reflection of the wireless signal to an action of the person.

6. The method as in claim 1, wherein the wireless signals include a first wireless signal; and
wherein monitoring the motion of the person includes: i) at a first wireless signal sensor, receiving a first reflection of the first wireless signal off the person, ii) at a second wireless signal sensor disparately located with respect to the first wireless senor, receiving a second reflection of the first wireless signal off the person, and iii) mapping a combination of a first signature of the first reflection of the wireless signal and a second signature of the second reflection of the wireless signal to an action of the person.

7. The method as in claim 1, wherein transmitting wireless signals from the wireless access point includes: transmitting a first wireless signal from the wireless access point at a first wireless frequency; and
wherein monitoring the motion of the person includes determining a frequency shift of a reflection of the first wireless signal off of the person in the network environment with respect to the first wireless frequency.

8. The method as in claim 1, wherein transmitting wireless signals from the wireless access point includes: transmitting a first wireless signal from the wireless access point to a communication device operated by the person; and
wherein monitoring the motion of the person includes analyzing a reflection of the first wireless signal off of the person.

9. The method as in claim 1, wherein detecting the presence of the person in the network environment includes: i) receiving a wireless communication from a mobile communication device operated by the person, and ii) mapping a unique identifier value in the received wireless communication to an identity of the person.

10. The method as in claim 9 further comprising:
based on the monitored motion of the person, communicating a message to the mobile communication device.

11. A system comprising:
management hardware operative to:
transmit wireless signals from a wireless access point in a network environment, the wireless access point providing wireless access to a remote network;
via the wireless signals transmitted from the wireless access point, detect presence of a person in a network environment; and
monitor motion of the person based on reflections of the wireless signals off the person in the network environment.

12. The system as in claim 11, wherein the management hardware is further operative to:
determine a location of the person in the network environment based on reception of the wireless signals at multiple different wireless sensors in the network environment.

13. The system as in claim 11, wherein the management hardware is further operative to:
monitor browsing activity of the person viewing products available for selection from a shelf in the network environment.

14. The system as in claim 11, wherein the management hardware is further operative to:
detect the person acquiring an item.

15. The system as in claim 11, wherein the wireless signals include a first wireless signal transmitted from the wireless access point; and
wherein the management hardware is further operative to: i) receive a first reflection of the first wireless signal off the person, and ii) map a signature of the reflection of the first wireless signal to an action of the person.

16. The system as in claim 11, wherein the wireless signals include a first wireless signal; and
wherein the communication management hardware is further operative to: i) at a first wireless signal sensor, receiving a first reflection of the first wireless signal off the person, ii) at a second wireless signal sensor disparately located with respect to the first wireless senor, receiving a second reflection of the first wireless signal off the person, and iii) mapping a combination of a first signature of the first reflection of the first wireless signal and a second signature of the second reflection of the first wireless signal to an action of the person.

17. The system as in claim 11, wherein the communication management hardware is further operative to:
transmit a first wireless signal from the wireless access point at a first wireless frequency; and
determine a frequency shift of a reflection of the first wireless signal off of the person in the network environment with respect to the first wireless frequency.

18. The system as in claim 11, wherein the communication management hardware is further operative to:
transmit a first wireless signal from the wireless access point to a communication device operated by the person; and
analyze a reflection of the first wireless signal off of the person.

19. The system as in claim 11, wherein the communication management hardware is further operative to: i) receive a wireless communication from a mobile communication device operated by the person, and ii) map a unique identifier value in the received wireless communication to an identity of the person.

20. The system as in claim 19, wherein the communication management hardware is further operative to:
based on the monitored motion of the person, communicate a message to the mobile communication device.

21. Computer-readable storage hardware having instructions stored thereon, the instructions, when carried out by computer processor hardware, cause the computer processor hardware to:
transmit wireless signals from a wireless access point in a network environment, the wireless access point providing wireless access to a remote network;
via the wireless signals transmitted from the wireless access point, detect presence of a person in a network environment; and
monitor motion of the person based on reflections of the wireless signals off the person in the network environment.
